(19) United States
(12) Patent Application Publication
(10) Pub. No.: US 2015/0280642 A1
(43) Pub. Date: Oct. 1, 2015

(54) SOLAR PHOTOVOLTAIC MODULE MONITORING AND CONTROL SYSTEM

(71) Applicant: Lesley Chisenga, Newark, CA (US)

(72) Inventor: Lesley Chisenga, Newark, CA (US)

(73) Assignee: Lesley Chisenga, Palo Alto, CA (US)

(21) Appl. No.: 14/224,470

(22) Filed: Mar. 25, 2014

(51) Int. Cl. H02S 50/10

(52) U.S. Cl. CPC H02S 50/10

(57) ABSTRACT

A solar photovoltaic sensing, control and monitoring system consisting of a sensing and control device that connects to the output of a solar module, collects the output voltage and current values, generates derivative values, such as cumulative energy, thereof and transmits the values to a monitoring device via a wired or wireless communication channel, and a monitoring device for receiving the values and transmitting instructions. The monitoring device may constitute a display and connect to a database or another device via a medium such as the internet. In some preferred embodiment, the sensing and control device includes an automatic switch or switches in series with the current carrying conductors connected to the solar module output. The switches disconnect the solar module output from the load. Furthermore, the sensing and control device may include an automatic switch in parallel to the current carrying conductors for bypassing the solar module output.

### FIELD OF THE INVENTION

This invention relates to a solar photovoltaic sensing, control and monitoring system consisting of a sensing and control device that is connected to the DC output of a solar photovoltaic module, collects the output voltage and current values of the solar module and may collect other parameters, such as the ambient temperature value, generates derivative values thereof, such as power and cumulative energy values, and transmits the values to a monitoring device by means of a wireless or wired communication channel. The monitoring device may constitute a local display interface or may be connected to a database or another device by means of a communication medium such as the internet.

In some preferred configuration, the sensing and control device constitutes an automatic switch or automatic switches in series with the current carrying conductors connected to the solar module output. The switches are operated so as to disconnect the solar module output from the load in the case of maintenance or in the case of development of a safety issue such as ground fault. In another preferred configuration, the sensing and control device includes a switch in parallel with the current carrying conductors, in addition to a switch or switches in series. Such a switch, if used in conjunction with the aforementioned switch connected in series, is provided so as to be used to bypass the solar module output, thereby enabling adjacent devices or solar modules to continue to provide power to the load. The disconnection feature may be desirable in an installation with multiple solar modules.

### BACKGROUND TO THE INVENTION

Solar photovoltaic module manufacturers, installers and system owners are increasingly demanding visibility of their photovoltaic solar systems performance. In the more prevalent installation configuration, solar modules are grouped together in a parallel, a series or a series and parallel combination and connected to a string or central inverter or load. This configuration provides a barrier to monitoring the performance of each individual solar module on the system.

In a system such as described in 0003, in the event of a failure of a single solar module on an installation, it is possible that the system owner would fail to notice that the installation is generating energy under capacity. The unnoticed downtime may result in lost revenue for the owner.

Furthermore, in a system such as described in 0003, maintenance workers may struggle to locate a failed solar module in a large installation that is already identified as underperforming. Locating the affected solar module may be a costly process for the owner; expensive techniques, such as thermal imaging, may be employed to identify a failed solar module.

Additionally, solar module manufacturers increasingly demand field performance data in order to improve their product performance and innovate for the next generation solar modules.

An important aspect of a solar photovoltaic installation is its safety. There are many instances of fire breaking out in solar installations. A fire breakout may result in damage to property the installation is located on, in addition to damage of the solar installation itself. Fire may result from a gradual degradation of a solar module element such as wiring, damage to a solar cell system in the module or a ground fault condition.

Currently existing systems are not equipped to solve these problems.
Herein are described techniques to address these problems.

### SUMMARY OF THE INVENTION

According to the present invention there is therefore provided a sensing and control device that connects to the output terminals of a solar module and collects the output voltage value and the output current value of the solar module and transmits such collected values or derivative values thereof to a monitoring device. Additionally, the sensing and control device may be configured to collect values including temperature and other parameters associated with an installation of a solar module. The values thus collected by the sensing and control device are transmitted to a monitoring device, which may constitute a local display and may connect to a database via a communication channel such as the internet. The transmission of the values between the sensing and control device and the monitoring device is conducted by either a wired or wireless communication channel. The monitoring device may constitute a display interface and may transmit the values to a secondary display device or database through media such as the internet. Furthermore, the monitoring device may transmit instructions to the sensing and control device. Additionally, the sensing and control device may comprise an automatic switch or automatic switches to disconnect the solar module from the load or to bypass the solar module output.

In embodiments the sensing and control device may constitute a current sensor, a voltage sensor, a temperature sensor and other sensors such as provided. In the embodiments the current sensor comprises either a magnetic coil around the current carrying conductor or a sensor resistor in series with a current carrying conductor and an amplifier. In the embodiments the current sensor or the amplifier is connected to the input of an analogue to digital converter; the output of the analogue to digital converter is connected to a processing unit. The processing unit is connected to a transceiver and a memory element. The output of the transceiver may be terminated with an antenna in the case of wireless communication or a cable in case of a wired channel.

In embodiments the voltage sensor may comprise a potential divider or an amplifier connected on the output of the solar module or across the current carrying conductors that transmit power from the solar module to the load. The current carrying conductors form the electrical connection between the solar module, which generates energy, and the load, which receives the energy. The load is connected on the output of the sensing and control device. The voltage sensor or amplifier is connected to the input of an analogue to digital converter; the analogue to digital output is connected to a processing unit. The processing unit is connected to a transceiver and a memory element. The output of the transceiver may be terminated with an antenna in the case of wireless communication or a cable in case of a wired channel.

In some preferred embodiments the sensing and control device constitutes both input and output terminals. The input terminals of the sensing and control device are connected to the solar module output terminals. The output terminals of the sensing and control device are connected to a load, such as an inverter, a similar sensing and control device, a battery, a solar module or a suitable load such as provided.

In some preferred embodiments the sensing and control device may be integrated into the junction box of a solar module or may replace the junction box altogether, thereby forming a smart solar module. In the embodiment of a smart solar module, wherein the sensing and control device replaces the junction box, the sensing and control device input connections are fitted to the solar module output conductors in the same manner the junction box input connections would have been fitted. In the embodiment of a smart solar module, wherein the sensing and control device is fitted inside the junction box, the sensing and control device input connections are fitted to the solar module output conductors in a similar manner as the junction box input connections are fitted, the output connections of the sensing and control device are connected to the output conductors of the junction box. In the embodiment of a smart solar module, wherein the sensing and control device replaces the junction box, the sensing and control device includes bypass diodes between the output conductors of the solar module, in a similar manner as those in the junction box are fitted.

In some preferred embodiments the values thus collected by the sensing and control device is transmitted wirelessly to the monitoring device by means of such media as ZigBee, Bluetooth or other ISM band platforms.

In embodiments the sensing and control device may receive instructions from the monitoring device by means of the established communication channel.

In embodiments the monitoring device may have a local display or may transmit values to another device or database via a media such as the internet.

A system constituting a sensing and control device and monitoring device such as described above may be used to overcome problems associated with lack of visibility of each individual solar module performance and may enhance system safety. Values or data transmitted from the sensing and control device may be used not only to ensure optimal performance of an installation but also to provide a early warning in case of safety issues developing. This visibility may be unlocked by the temperature, voltage or current reporting feature or an alarm system such as implemented on the sensing and control device.

Furthermore, the availability of an automatic switch or automatic switches on the sensing and control device may improve safety. The switch may be configured to disconnect the solar module from the load in the event of safety violations such as may result from a ground fault or arcing on the system.

### BRIEF DESCRIPTION OF THE DRAWINGS

These and other aspects of the invention will now be further described, by way of example only, with reference to the accompanying figures in which:

FIG. 1 shows an example of a system of a smart solar module, a monitoring device and a load. A smart solar module is defined herein as a single integrated unit consisting of a solar module and a sensing and control device. The monitoring device is connected to a database or a secondary display device via a communication channel.

FIG. 2 shows an example of a system of a solar module, a sensing and control device, a monitoring device and a load. The sensing and control device is connected to the solar module via the junction box. The monitoring device is connected to a database or display device via a communication channel. The monitoring device constitutes a local display.

FIG. 3 shows an example of a system of a solar module, a sensing and control device, a monitoring device and a load. The sensing and control device is connected to the solar module via the junction box. The monitoring device is connected to a database or display device via a communication channel. The monitoring device does not constitute a local display.

FIG. 4 shows an example of a system of a solar module, a sensing and control device, a monitoring device and a load. The sensing and control device is connected to the solar module via the junction box. The monitoring device is connected to a database or display device via a communication channel. The monitoring device does not constitute a local display. The sensing and control device and the monitoring device communicate via a wired communication channel.

FIG. 5 shows an example of details of a basic sensing and control device that is provided for connection to a solar module on the input terminals and to a load on the output terminals. The device constitutes an antenna for wireless communication.

FIG. 6 shows an example of details of a basic sensing and control device that is provided for connection to a solar module on the input terminals and to a load on the output terminals. The device constitutes a terminal for connection to a wired communication channel.

FIG. 7 shows an example of details of a basic sensing and control device that is provided for connection to a solar module on the input terminals and to a load on the output terminals. The device constitutes bypass diodes.

FIG. 8 shows an example of details of a sensing and control device that is provided for integration to a solar module and to replace the junction box. The device constitutes bypass diodes.

FIG. 9 shows an example of details of a sensing and control device that is provided for integration to a solar module and to replace the junction box. The device constitutes switches in place of bypass diodes.

FIG. 10 shows an example of details of a sensing and control device that is provided for connection to the output terminals of a solar module. The device constitutes a switch in series with a current carrying conductor.

FIG. 11 shows an example of details of a sensing and control device that is provided for connection to the output terminals of a solar module. The device constitutes a switch on each of the current carrying conductors.

FIG. 12 shows an example of details of a sensing and control device that is provided for connection to the output terminals of a solar module. The device constitutes a switch and a current sensor on each of the current carrying conductors.

FIG. 13 shows an example of details of a sensing and control device that is provided for connection to the output terminals of a solar module. The device constitutes a switch in series with a current carrying conductor and a second switch in parallel to the current carrying conductors.

FIG. 14 shows an example of details of a monitoring device that is provided for communication to a sensing and control device and a database. The device constitutes an antenna for wireless communication and a terminal for wired communication

FIG. 15 shows an example of a system of a smart solar module, defined herein as an integrated unit consisting of a solar module and a sensing and control device, and a load.

FIG. 16 shows an example of a system of sensing devices connected to solar modules on the input and connected in a parallel configuration to a load on the output.

FIG. 17 shows an example of a system of sensing devices connected to solar modules on the input and connected in a series configuration to a load on the output.

FIG. 18 shows an example of a system of smart solar modules connected in a parallel configuration to a load.

FIG. 19 shows an example of a system of smart solar modules connected in a series configuration to a load.

FIG. 20 shows an example of a system of sensing and control devices where in one solar module is bypassed by the activation of switches.

### DESCRIPTION OF PREFERRED EMBODIMENTS

Broadly speaking, herein is described a system constituting an electronic sensing and control device that connects on the output of a solar photovoltaic module, collects output voltage value and current value, and other parameters such as a temperature value, and transmits the values or derivative values thereof to a monitoring device by means of a wired or wireless communication channel. Furthermore, the sensing and control device may constitute an automatic switch or automatic switches to disconnect the solar module from the load.

The monitoring device may constitute a local display and may transmit values or data to a secondary device or database by media such as the internet. The monitoring device may transmit instructions to the sensing and control device by means of an existing communication channel.

The sensing and control device collects the output voltage value of a solar photovoltaic module by means of a voltage sensor connected on the output of the module and collects the output current value by means of a current sensor; the current sensor may be a resistor in series with the current carrying conductor or a magnetic coil around the current carrying conductor transferring current between the solar module and a load. Additionally, the device may collect a temperature value or other values by means of a corresponding sensor such as provided. The output values of the sensors such as provided may be amplified or attenuated by an amplifier. The output values of the sensors such as provided or the output of an amplifier such as used are converted to digital format by an analogue to digital converter. A processing unit receives the output values of the analogue to digital converter corresponding to the current, voltage and temperature values. Derivative values, including power and cumulative energy, may be generated by the processing unit. The processing unit processes the values into a format suitable for transmission. A transceiver connected to the output of the processing unit transmits the data by means of a wired or wireless channel to a monitoring device. In the case of a wireless system, an antenna is connected to the transceiver. In the case of a wired system, a cable is connected to the transceiver. Additionally, the sensing and control device may receive instructions from the monitoring device.

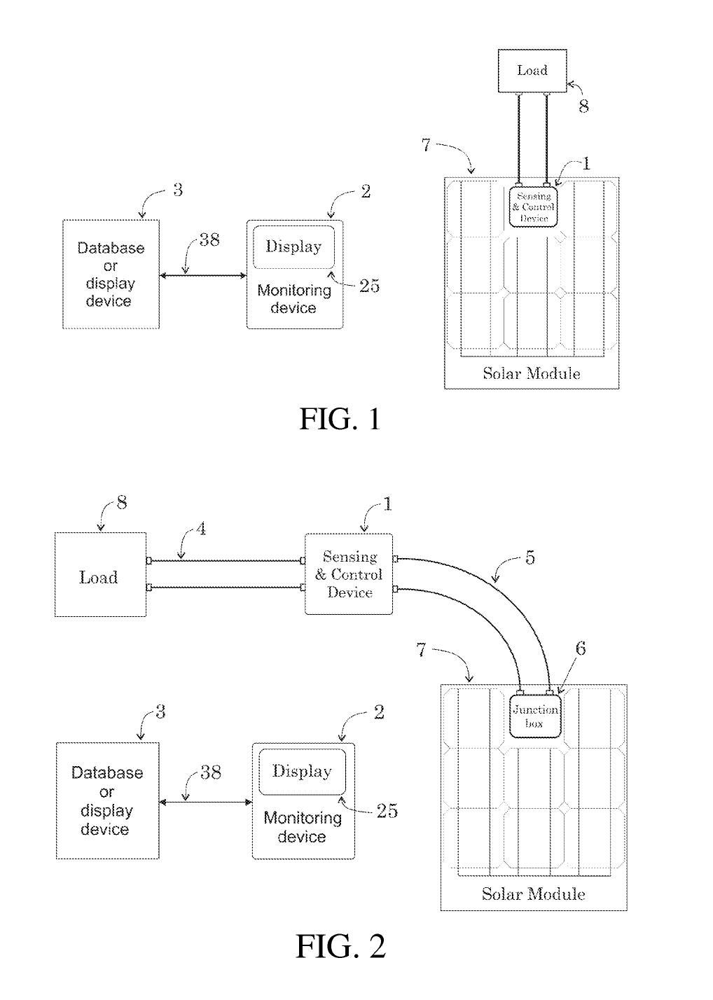

FIG. 1 is a diagram illustrating the embodiment of a system comprising an integrated unit of a sensing and control device 1 and a solar module 7, a load 8, a monitoring device 2 with a display 25, and a database or display device 3. The monitoring device communicates with the database or display device 3 by means of a communication channel 38. In the embodiment the sensing and control device 1 communicates with the monitoring device 2 by means of a wireless channel such as ZigBee or Bluetooth. In the embodiment the sensing and control device 1 is integrated onto the solar module, in the same way the junction box 6 is otherwise integrated, and constitutes a single unit herein referred to as smart solar module.

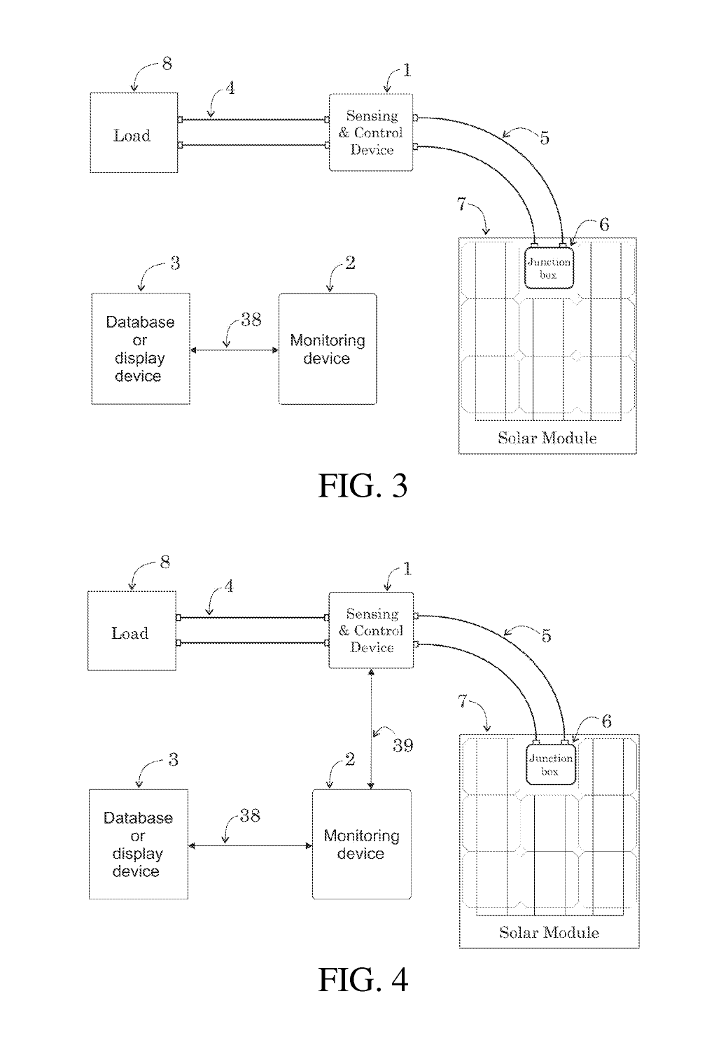

FIG. 2 is a diagram illustrating another preferred embodiment of a system comprising a sensing and control device 1, a solar module 7 with a junction box 6, a load 8, a monitoring device 2 with a display 25 and a database or display device 3. In the embodiment the sensing and control device 1 is connected to the output terminals of the junction box by means of current carrying conductors 5. A second pair of current carrying conductors 4 connects the sensing and control device 1 to the load 8. In the embodiment the sensing and control device may be connected to the junction box either on site during the installation of the system or in a factory prior to transportation to the location of installation. FIG. 3 illustrates an embodiment wherein the monitoring device 2 does not constitute a local display. FIG. 4 illustrates an embodiment wherein the communication channel between the sensing and control device 1 and the monitoring device 2 is by means of a cable 39.

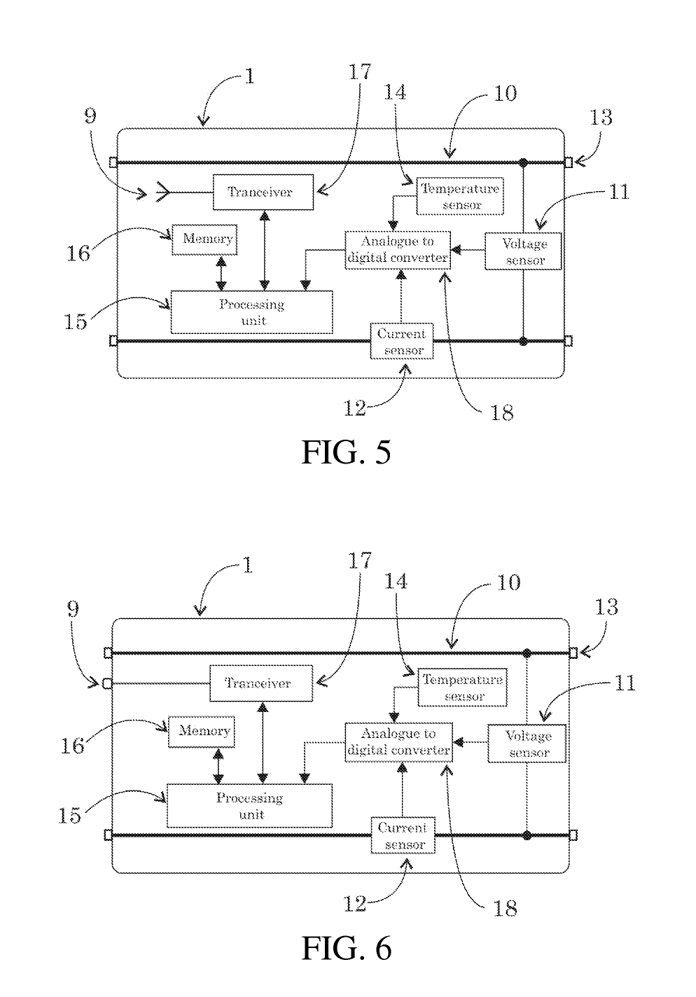

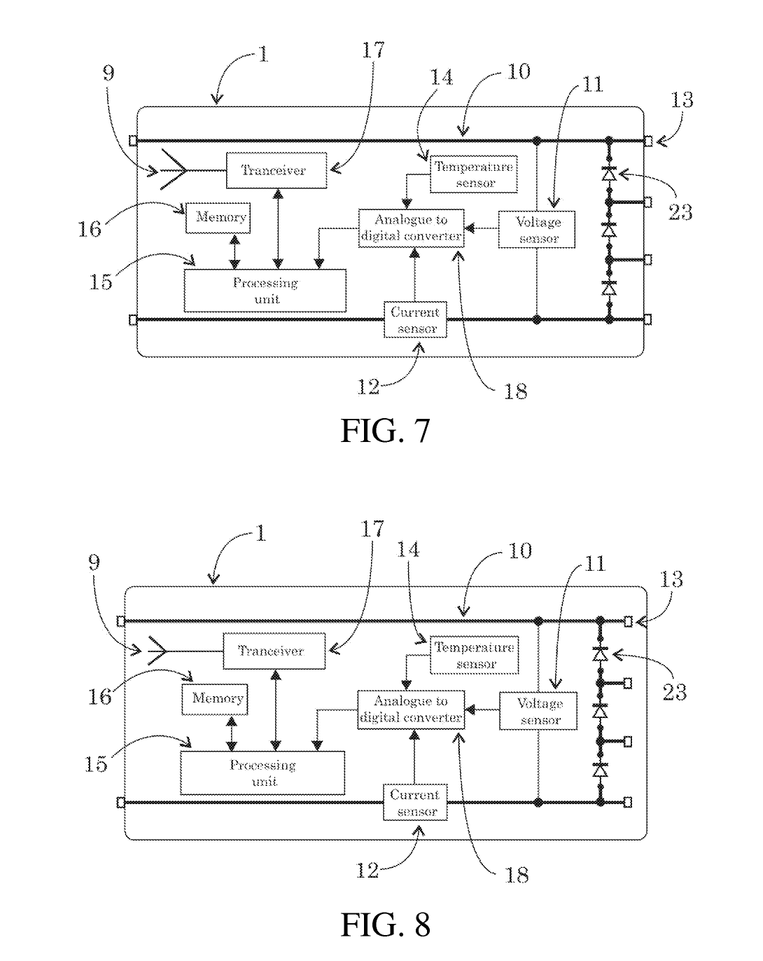

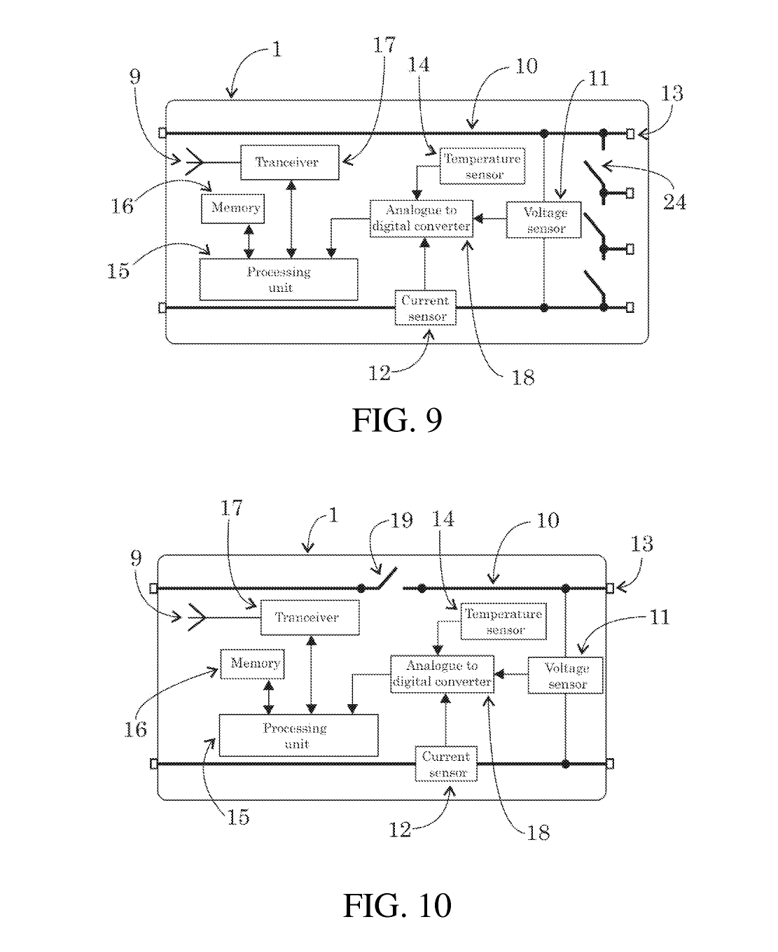

Herein is described the mechanism of operation of the sensing and control device 1 by way of examples. FIG. 5 is a diagram illustrating the main features of the sensing and control device 1. The sensing and control device 1 is connected to the solar module 7 on the input and to a load on the output by means of terminals 13. The current sensor 12 senses the value of the current flowing in one of the current carrying conductors 10, equal to the current generated by the solar module under normal conditions. The voltage sensor 11 senses the voltage across the current carrying conductors 10. The temperature sensor 14 senses the temperature, either ambient temperature or specified temperature according to the preferred location of the sensor. The analogue to digital converter 18 receives the values from the sensors and converts the values from the original analogue format to digital values. The processing unit 15 receives the digital values from the analogue to digital converter 18 and performs further processing, including the generation of derivative values such as power or cumulative energy. Some values or derivative values are stored in memory 16. The transceiver 17 receives the values or derivatives and transmits the values through an antenna 9. FIG. 6 is a diagram illustrating the embodiment wherein the transceiver 17 transmits the values through a cable connected to the terminal 45. FIG. 7 is a diagram illustrating the embodiment wherein the bypass diodes 23 are integrated onto the sensing and control device 1. Bypass diodes are normally included in the junction box in order to provide a level of protection to a solar module. In the embodiment the sensing and control device 1 is provided for connection to the solar module terminals during installation or in a factory prior to shipping to a location of installation. FIG. 8 is a diagram illustrating an example of the embodiment wherein the bypass diodes are integrated onto the sensing and control device 1. Furthermore, the terminals 13 for connection to the solar module output conductors are embedded into the sensing and control device. In the embodiment, the sensing and control device 1 is provided for integration onto the solar module. In the embodiment the sensing and control device 1 is integrated onto the solar module 7 during the fabrication process of the solar module or in a factory. The integrated sensing and control device and solar module are certified as a single unit. FIG. 9 is a diagram illustrating the sensing and control device constituting switches 24 in place of bypass diodes 23. In the embodiment the switches 24 may be semiconductor devices such as MOSFETs or mechanical units such as relay devices. In the embodiment, the switches 24 may be controlled by the processing unit.

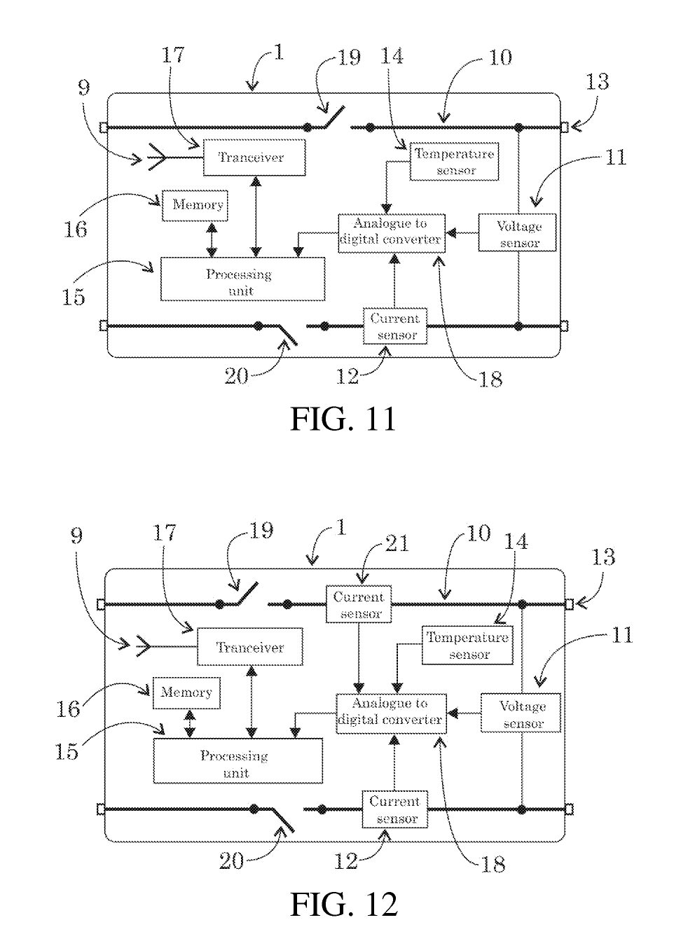

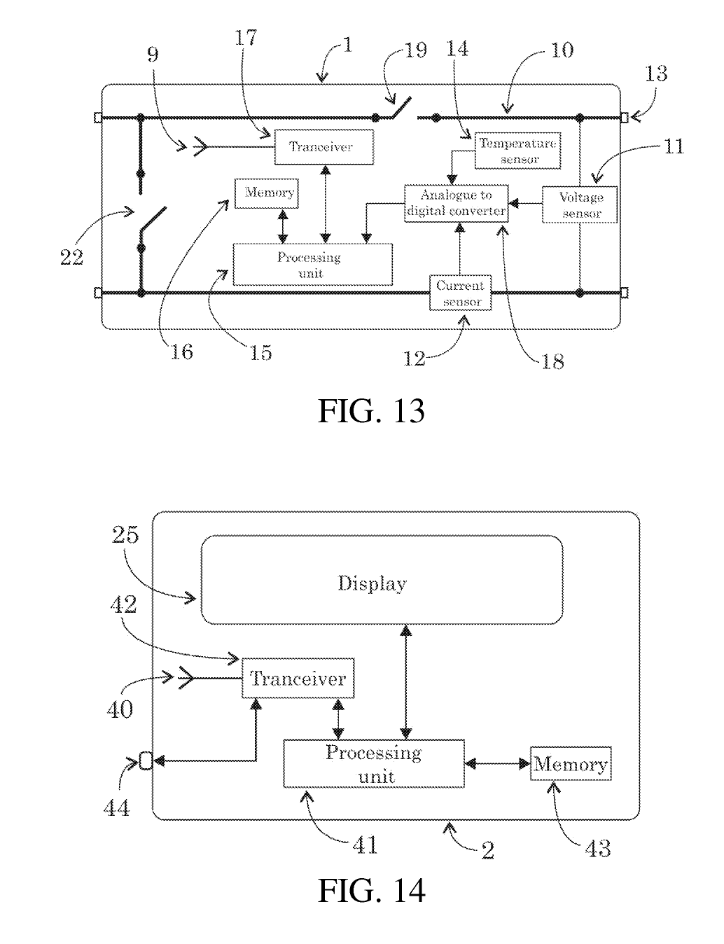

FIG. 10 is a diagram illustrating the sensing and control device 1 wherein a switch 19 is fitted in series with a current carrying conductor 10. In the embodiment the switch 19 can be operated to open and thereby disconnect the solar module from the load. FIG. 11 is a diagram illustrating the sensing and control device wherein switches 19 and 20 are provided to reside one on each of the current carrying conductors 10. In the embodiment both terminals of the solar module can be disconnected from a load. FIG. 12 is a diagram illustrating the current sensor 12 and another current sensor 21, each in series with a separate current carrying conductor. In the embodiment the current sensors may be used to detect safety issues such as ground fault. Ground fault is detected when the current running though the current sensor 12 and that running through the current sensor 21 are unequal. In the event ground fault is detected, switch 19 or switch 20 or both may be opened in order to interrupt the fault. FIG. 13 is a diagram illustrating a sensing and control device 1 wherein switch 22 between the current carrying conductors 10 is provided. In the embodiment switch 22 is provided to bypass the output of the solar module when the sensing and control device 1 is part of a system wherein adjacent devices provide power to the same load. In the embodiment switch 19 may be operated to open when switch 22 is operated to close.

Herein is described the mechanism and operation of the monitoring device 2. FIG. 14 is a diagram illustrating details of an example of a monitoring device 2. In the embodiment the transceiver 42 collects values transmitted by the sensing and control device 1 by means of the antenna 40. The processing unit 41 receives the values from the transceiver 42. The processing unit 41 may send the values to be displayed on the display 25, or may send the values for storage in memory 43 or may send the values to the transceiver and terminal 44 for transmission to another device or database. The monitoring device 2 may send instructions to the sensing and control device 1. The instructions may originate on the monitoring device 2 or from another device connected to the monitoring device 2.

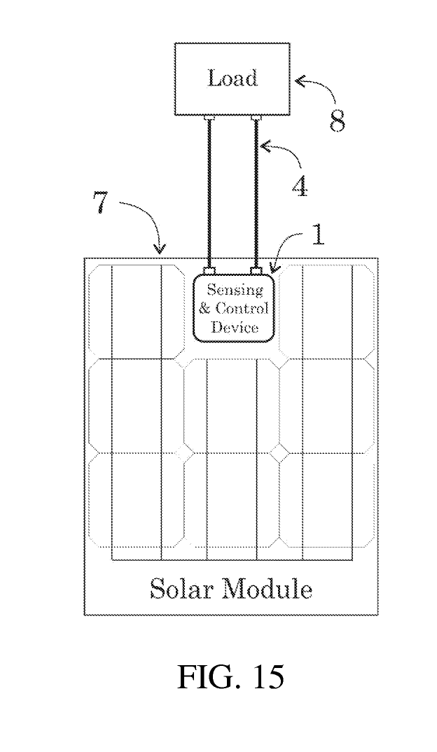

Herein is described the system examples of the sensing and control device 1. FIG. 15 is a diagram illustrating an integrated sensing and control device 1 and solar module 7, connected to a load 8 by means of current carrying conductors 4. In the embodiment the sensing and control device and the solar module are manufactured or assembled and certified as a single unit.

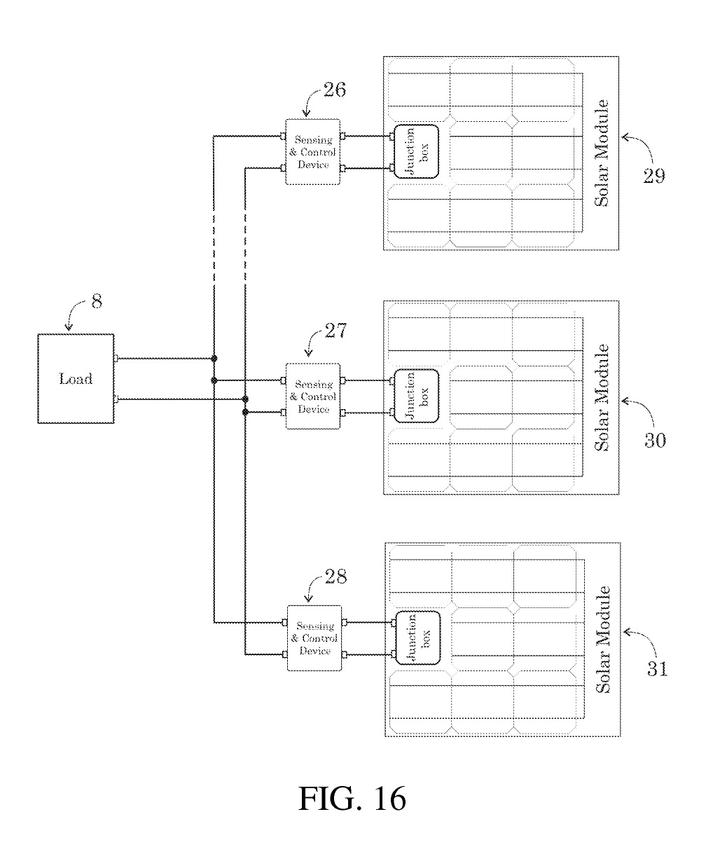

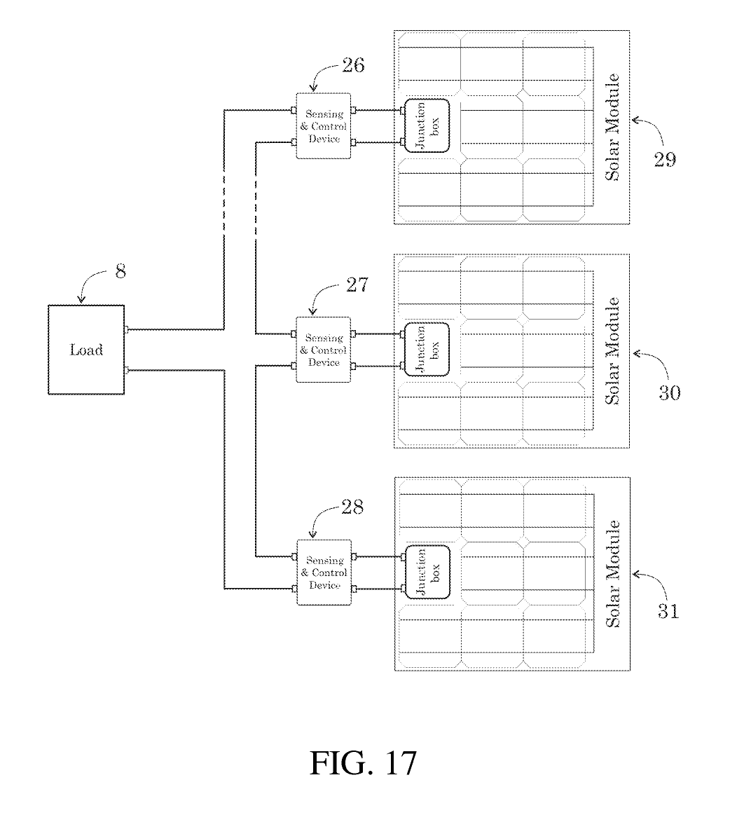

FIG. 16 is a diagram illustrating a system constituting a parallel connection of sensing and control devices to a load. In the embodiment the input of the sensing and control device 26 is connected to solar module 29, that of the sensing and control device 27 is connected to solar module 30 and that of the sensing and control device 28 is connected to solar module 31. The outputs of all the sensing and control devices are connected to a load 8. FIG. 17 is a diagram illustrating a system wherein the outputs of the sensing and control devices are connected to the load in a series configuration.

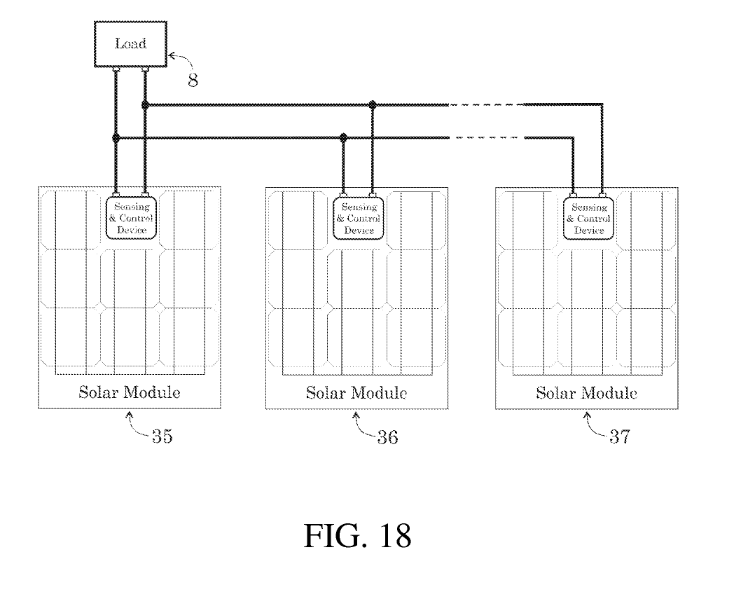

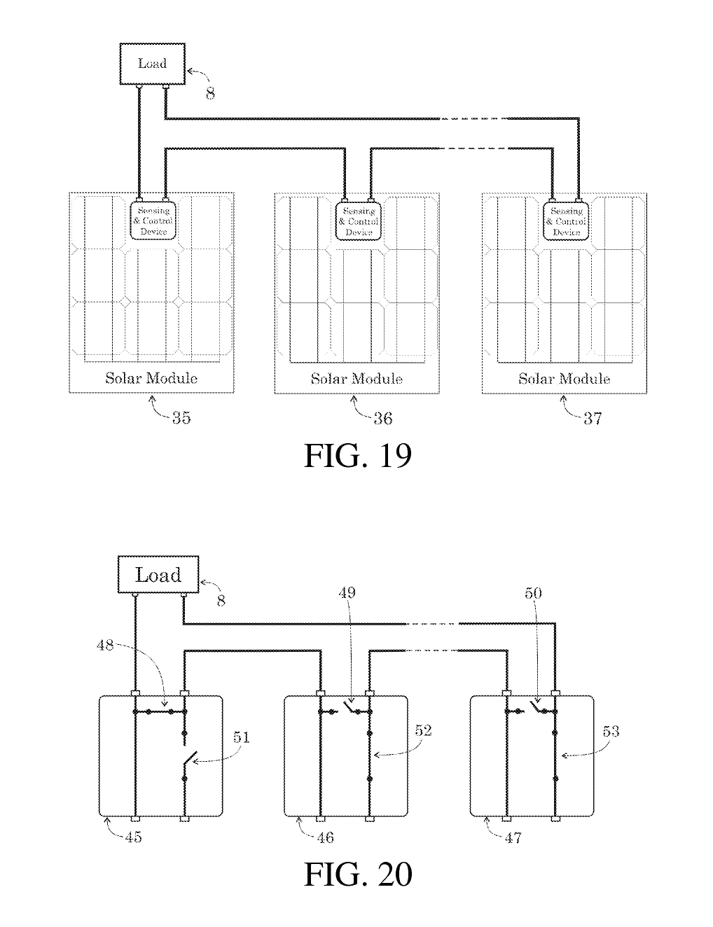

FIG. 18 is a diagram illustrating a system constituting a parallel connection of smart solar module to a load; wherein a smart solar module is an integrated sensing and control device and solar module, manufactured and certified as a single unit. In the embodiment the output of the smart solar module 35, smart solar module 36 and smart solar module 37 are connected in parallel to the load 8. FIG. 19 is a diagram illustrating a system wherein the outputs of the smart solar modules are connected to the load 8 in a series configuration.

FIG. 20 is a diagram illustrating a system of sensing and control devices and a load wherein the output of the sensing and control device 45 is bypassed by means of the operation of the series switch 51 and the parallel switch 48. In the embodiment switch 48 is closed and switch 51 is open, thereby enabling the adjacent sensing and control devices, 46 and 47, to remain connected to the load 8. In the embodiment the switches 49, 50, 52 and 53 on the sensing and control devices 46 and 47 are in a state that enables the two devices to maintain connection to the load 8.

Herein is described, broadly speaking, some preferred embodiments. In some preferred embodiment the sensing and control device comprises input and output terminals. The input terminals are connected to the output terminals of the solar module, either in a factory, during installation or after installation of the solar module. The output terminals may be connected to the output of another sensing and control device, an inverter, a battery or a suitable load such as provided. Multiple loads or devices may be connected on the output of the sensing and control device.

In another preferred embodiment the sensing and control device is integrated onto the solar module and either replaces the junction box or is embedded into the junction box. In the embodiment the device may be built into the solar module structure during the manufacturing process of the solar module or may be attached afterwards in such a way that it becomes an integrated part of the solar module. In the embodiment, wherein the sensing and control device replaces the junction box, the sensing and control device is integrated in the same way that a junction box is integrated on the solar module.

In another preferred embodiment the sensing and control device may be fitted with an automatic switch or automatic switches that can break the circuit of the current carrying conductor of a solar module in case of safety violation or maintenance. Furthermore, a switch may be closed so as to bypass the output of the solar module by creating a short circuit on to the load. In the first mode, the sensing and control device may be pre-programmed to break the circuit under specific conditions such as high sensed temperature or ground fault. In the second mode, the sensing and control device may be instructed to break the circuit of the current carrying conductor via an instruction sent from the monitoring device. Switches such as used may be semiconductor or electromechanical in construction.

The sensing and control device is primarily for use in installations of solar photovoltaic systems wherein individual solar module monitoring and control and system safety are sought. Alternatively, the sensing and monitoring device can be used in modular battery systems wherein visibility of performance and safety is desirable. The device provides significant benefits in terms of data monitoring and safety provision in installations.

1. A photovoltaic sensing, control and monitoring system, the system comprising:
a sensing and control device and a monitoring device; a sensing and control device for sensing an output voltage value and an output current value of a solar module and for transmitting the said voltage value or said current value or derivative values thereof to a monitoring device by means of a wired or wireless communication medium; and a monitoring device for receiving said current value or said voltage value or said derivative values such as transmitted by said sensing and control device, and for transmitting instructions to said sensing and control device;
wherein said sensing and control device comprising:
input terminals, wherein said input terminals are connected to the output terminals of said solar module;
output terminals, wherein said output terminals are connected to a load or device for receiving voltage and current generated by said solar module;
current carrying conductors, wherein said current carrying conductors provide electrical connection between said input and said output terminals of said sensing and control device;
a voltage sensor, wherein said voltage sensor senses the voltage value on the output of said solar module; wherein said voltage sensor is connected across said current carrying conductors; said voltage sensor comprising a potential divider or a voltage amplifier element;
a current sensor, wherein said current sensor senses the current value generated by said solar module; said current sensor comprising either a sensor resistor in series with a current carrying conductor, wherein said current carrying conductor connects an input terminal to an output terminal of said sensing and control device, or a magnetic sensor around said current carrying conductor; wherein said current sensor may further constitute an amplifier for reducing or increasing said current value received by said current sensor;
and a processing circuit, said processing circuit for receiving said voltage value and said current value from said voltage sensor and said current sensor and for processing said values, for generating derivative values and for transmitting said current value or said voltage value or said derivative values to said monitoring device; wherein said processing circuit consists of an analogue-to-digital converter for converting said current value and said voltage value to digital values; a processor unit for receiving said digital values and for generating derivative values of said digital values, wherein said derivative values may include power or cumulative energy, and for executing general instructions; and a transceiver for transmitting said digital values or said derivative values to said monitoring device and for receiving instructions from said monitoring device; wherein said transceiver is connected to either an antenna in the case of a wireless communication channel or a cable in the case of a wired communication channel;
wherein said monitoring device comprising:
a transceiver, said transceiver for receiving said voltage value or said current values or derivative values such as transmitted by said sensing and control device; said transceiver for transmitting instructions to said sensing and control device; wherein said transceiver is connected to an antenna in the case of a wireless communication channel or a cable in the case of a wired communication channel;
a processing unit, said processing unit for formatting and for processing said voltage value or said current value or said derivative values.

2. A photovoltaic sensing, control and monitoring system according to claim 1 wherein said sensing and control device further comprises a temperature sensor for sensing temperature value, wherein said temperature value is converted to a digital value; wherein said digital value is transmitted to said monitoring device by said transceiver.

3. A photovoltaic sensing, control and monitoring system according to claim 1 wherein said sensing and control device further comprises a memory device for storing said current value or said voltage value or said temperature value or said derivative values; wherein said derivative values may include cumulative energy.

4. A photovoltaic sensing, control and monitoring system according to claim 1 wherein said monitoring device further comprises a communication interface for connecting to a database or a device.

5. A photovoltaic sensing, control and monitoring system according to claim 1 wherein said sensing and control device further comprises a switch or plurality of switches in series with one or more of said current carrying conductors; wherein said switch or plurality of switches may be semiconductor or electromechanical; wherein said switch or plurality of switches are automatically opened or closed by said sensing and control device.

6. A system of a sensing and control device and a monitoring device according to claim 5 wherein said sensing and control device further comprises a switch connected between said current carrying conductors; wherein said switch may be semiconductor or electromechanical; wherein said switch being automatically opened or closed by said sensing and control device.

7. A system of a smart solar module and a monitoring device; said smart solar module for generating current and voltage; for sensing values of said current and said voltage and for generating derivative values thereof, and for transmitting said current value or voltage value or said derivative values to said monitoring device; and said monitoring device for receiving said voltage value or said current value or said derivative values such as transmitted by said sensing and control device and for transmitting instructions to said sensing and control device;
wherein said smart module comprising:
a solar module, wherein said solar module produces current and voltage;
and a sensing and control device, wherein said sensing and control device senses the output current value and voltage value of said solar module, and transmits said voltage value or said current value or said derivative values to said monitoring device by means of a wired or wireless communication medium; wherein said solar module and said sensing and control device are integrated during fabrication and are certifiable as a single unit;
said sensing and control device comprising:
output terminals, said output terminals being connected to a load or device for receiving voltage and current generated by said solar module;
a voltage sensor, said voltage sensor for sensing the output voltage value of the said solar module; wherein said voltage sensor connects across current carrying conductors on the output of said solar module; said voltage sensor comprises a potential divider or a voltage amplifier;
a current sensor, said current sensor for sensing the current generated by said solar module;
wherein said current sensor comprises either a sensor resistor in series with a current carrying conductor, wherein said current carrying conductor connects an output conductor of said solar module and an output terminal of said sensing and control device, or a magnetic sensor around said current carrying conductor; said current sensor may further constitute an amplifier;
and a processing circuit, said processing circuit for receiving the output values of said current sensor and said voltage sensor and for processing said current value or said voltage value, for generating derivative values thereof and for transmitting said voltage value or said current value or said derivative values to said monitoring device; wherein said processing circuit consists of an analogue-to-digital converter for converting said current value or said voltage value to digital values; a processor unit for receiving said digital values and for generating said derivative values of said digital values, wherein said derivative values may include power or cumulative energy, and for executing general instructions; and a transceiver for transmitting said digital values or said derivative values to said monitoring device and for receiving instructions from said monitoring device; wherein said transceiver is connected to an antenna in the case of a wireless communication channel or a cable in the case of a wired communication channel;
wherein said monitoring device comprising:
a transceiver, said transceiver for receiving said voltage value or said current value or said derivative values such as transmitted by said sensing and control device; said transceiver for transmitting instructions to said sensing and control device; wherein said transceiver is connected to an antenna in the case of a wireless communication channel or a cable in the case of a wired communication channel; a processing unit, said processing unit for formatting and for processing said voltage value or said current value or said derivative values.

8. A system of a smart solar module and a monitoring device according to claim 7 wherein said sensing and control device further comprises a temperature sensor for sensing temperature value, wherein said temperature value is converted to a digital value; wherein said digital value is transmitted to a monitoring device by said transceiver.

9. A system of a smart solar module and a monitoring device according to claim 7 wherein said sensing and control device further comprises a memory device for storing said current or said voltage value or said temperature value or said derivative values; wherein said derivative values may include cumulative energy.

10. A system of a smart solar module and a monitoring device according to claim 7 wherein said sensing and control device further comprises an indicator of status; wherein said indicator is a light emitting or audio device.

11. A system of a smart solar module and a monitoring device according to claim 7 wherein said monitoring device further comprises a communication interface for connecting to a database or a device.

12. A system of a smart solar module and a monitoring device according to claim 7 wherein said sensing and control device further comprises a switch or plurality of switches in series with one or more of said current carrying conductors; wherein said switch or plurality of switches may be semiconductor or electromechanical; wherein said switch or plurality of switches being automatically opened or closed by said sensing and control device.

13. A system of a smart solar module and a monitoring device according to claim 12 wherein said sensing and control device further comprises a switch connected between said current carrying conductors; wherein said switch may be semiconductor or electromechanical; wherein said switch being automatically opened or closed by said sensing and control device.

14. A system of a smart solar module and a monitoring device according to claim 7 wherein said sensing and control device further comprises a plurality of bypass diodes or switches; wherein said bypass diodes or switches are connected across the output conductors of said solar module; wherein said switches may be semiconductor or electromechanical.

15. An apparatus, herein referred to as a sensing and control device, for sensing the output characteristic values of a solar module, including voltage value and current value; and for transmitting said current value or voltage value or derivative values thereof to a monitoring device by means of a wired or wireless communication medium;
wherein said sensing and control device comprising:
input terminals, wherein said input terminals are connected to the output terminals of said solar module;
output terminals, wherein said output terminals are connected to a load or device for receiving voltage and current generated by said solar module;
current carrying conductors, wherein said current carrying conductors provide electrical connection between said input terminals and said output terminals of said sensing and control device;
a voltage sensor, wherein said voltage sensor senses the voltage on the output of said solar module; wherein said voltage sensor is connected across said current carrying conductors;
wherein said voltage sensor comprises a potential divider or a voltage amplifier;
a current sensor, said current sensor for sensing the current generated by said solar module;
wherein said current sensor comprises either a sensor resistor in series with a current carrying conductor, wherein said current carrying conductor connects an input terminal to an output terminal of said sensing and control device, or a magnetic sensor around said current carrying conductor; said current sensor may further constitute an amplifier;
a processing circuit, said processing circuit for receiving said current value and said voltage value, for processing said current value and said voltage value, for generating derivative values thereof, said derivative values may include power or cumulative energy, and for transmitting said current value or voltage value or said derivative values to said monitoring device; said processing circuit consisting of an analogue-to-digital converter for converting said current value and said voltage value to digital values; a processor unit for receiving said digital values and for generating derivative values thereof and for executing general instructions; and a transceiver for transmitting said digital values or derivative values to said monitoring device and for receiving instructions from said monitoring device; said transceiver being connected to either an antenna in the case of a wireless communication channel or a cable in the case of a wired communication channel.

16. An apparatus according to claim 15 wherein said sensing and control device further comprises a temperature sensor for sensing a temperature value, wherein said temperature value is converted to a digital value, wherein said digital value is transmitted to said monitoring device by said transceiver.

17. An apparatus according to claim 15 wherein said sensing and control device further comprises a memory device for storing said current value or said voltage value or said temperature value or said derivative values; wherein said derivative values may include cumulative energy.

18. An apparatus according to claim 15 wherein said sensing and control device further comprises a switch or plurality of switches in series with one or more of said current carrying conductors; wherein said switch or plurality of switches may be semiconductor or electromechanical; wherein said switch or plurality of switches being automatically opened or closed by the electronic circuit of said sensing and control device.

19. An apparatus according to claim 18 wherein said sensing and control device further comprises a switch connected between said current carrying conductors; wherein said switch may be semiconductor or electromechanical; wherein said switch being automatically opened or closed by said sensing and control device electronic circuit.

20. An apparatus according to claim 15 wherein said sensing and control device further comprises a plurality of bypass diodes or switches, wherein said bypass diodes or switches are connected across the output conductors of said solar module.
